(19) United States
(12) Patent Application Publication
(10) Pub. No.: US 2021/0062032 A1
(43) Pub. Date: Mar. 4, 2021

(54) POLLUTANT MITIGATING COATING COMPOSITIONS AND METHODS FOR THE MITIGATION OF POLLUTANTS

(71) Applicant: Ecobond LBP, LLC, Arvada, CO (US)

(72) Inventors: James M. Barthel, Arvada, CO (US); Trevor C. Schwaab, Arvada, CO (US); Eric Heronema, Arvada, CO (US); Michael L. Enos, Colorado Springs, CO (US)

(21) Appl. No.: 17/048,463

(22) PCT Filed: Apr. 19, 2019
(86) PCT No.: PCT/US2019/028365

§ 371 Date: Oct. 16, 2020

Related U.S. Application Data
(60) Provisional application No. 62/660,092, filed on Apr. 19, 2018.

(51) Int. Cl. C09D 133/08

(52) U.S. Cl. CPC C09D 133/08; C08K 2003/222

(57) ABSTRACT

A coating composition and method for the mitigation of pollutants using the coating composition. The coating composition is effective to reduce the re-emission of pollutants from a surface that is imbibed with the pollutants. Pollutants that can be mitigated include those found in tobacco smoke and marijuana smoke, such as ammonia, 2-butatone (MEK), benzene and naphthalene. The coating composition is effective to mitigate such pollutants over a long period of time as compared to know compositions, and therefore significantly reduce the emission of thirdhand smoke. The coating composition may also increase the fire resistance of the surface.

### FIELD

This disclosure relates to the field of paint compositions, specifically paint compositions that are formulated to mitigate the effects of pollutants, such as pollutants originating from tobacco and marijuana smoke.

### BACKGROUND

A recent poll found that 40 million adults in the United States smoke marijuana. According to the Center for Disease Control, an estimated 37.8 million adults reported smoking tobacco. It is well established that the smoking of these and similar products result in the emission of pollutants into the environment. Such pollutants can include various heavy metals such as lead and arsenic, as well as carcinogens such as cyanide, aldehydes, carbon monoxide, carbon dioxide, sulfur dioxide, nitrogen oxides, polycyclic aromatic hydrocarbons (PAH), ammonia and harmful organic solvents such as benzene and toluene. Initial studies in 2007 published by the American Chemical Society report that the smoke produced from marijuana can contain up to 20 times more ammonia, and three to five times the amount of cyanide as compared to tobacco.

Secondhand smoke is well known to impair blood vessel function and increase the risk of heart attacks and atherosclerosis. Thirdhand smoke is a term for the pollutants from the secondhand smoke that remain on surfaces, even after the secondhand smoke has been cleared. For example, pollutants from secondhand smoke can be deposited on the walls and ceilings of a building. A study performed in 2010 by the American Cancer Society found that chemicals produced by smoking and deposited onto a surface can then be re-emitted into the air, and can react with oxidants and other compounds to yield secondary pollutants. Thirdhand smoke is residual nicotine and other chemicals left on indoor surfaces by tobacco smoke. People are exposed to these chemicals by touching contaminated surfaces or breathing in the off-gassing from these surfaces. This residue is thought to react with common indoor pollutants to create a toxic mix including cancer causing compounds, posing a potential health hazard to nonsmokers—especially children. Thirdhand smoke clings to clothes, furniture, drapes, walls, bedding, carpets, dust, vehicles and other surfaces long after smoking has stopped. The residue from thirdhand smoke builds up on surfaces over time.

To remove the residue, hard surfaces, fabrics and upholstery need to be regularly cleaned or laundered. Thirdhand smoke can't be eliminated by airing out rooms, opening windows, using fans or air conditioners, or confining smoking to only certain areas of a home. Children and nonsmoking adults might be at risk of tobacco related health problems when they inhale, swallow or touch substances containing thirdhand smoke. Infants and young children might have increased exposure to thirdhand smoke due to their tendency to mouth objects and touch affected surfaces. Thirdhand smoke is a relatively new concept, and researchers are still studying its possible dangers. In the meantime, the only way to protect nonsmokers from thirdhand smoke is to create a smoke-free environment.

### SUMMARY

Accordingly, it is now recognized that there is a need for a product to mitigate the potentially harmful pollutants that remain on surfaces after secondhand smoke has dissipated. This need is expanding with the increase in legalized marijuana for both medical and recreational purposes.

It is an objective of the present disclosure to provide a coating for the mitigation of such thirdhand smoke pollutants. In one embodiment, a coating composition is disclosed that is formulated for the mitigation of pollutants that are disposed on a surface, e.g., thirdhand smoke. The coating composition comprises a resin, a pollutant mitigating agent, and a liquid carrier.

A number of feature refinements and additional features are applicable to the foregoing embodiment of a coating composition. These feature refinements and/or additional features may be used individually or in any combination. As such, each of the following feature refinements and additional features may be, but are not required to be, used with any other feature or combination of features.

In the foregoing embodiment, the resin may be selected from the group consisting of vinyl acetate-ethylene resin, styrene acrylic resin, elastomeric resins and combinations thereof. In one refinement, the resin comprises vinyl acetate-ethylene resin. In another refinement, the resin comprises styrene acrylic resin.

In another refinement, the coating composition comprises at least about 10 wt. % of the resin. In a further refinement, the coating composition comprises not greater than about 40 wt. % of the resin.

The pollutant mitigating agent may comprise a phosphate compound. In one refinement, the pollutant mitigating agent is selected from the group consisting of monocalcium phosphate, tricalcium phosphate, and combinations thereof. In a further refinement, the pollutant mitigating agent comprises monocalcium phosphate. In another refinement, the pollutant mitigating agent comprises tricalcium phosphate.

The coating composition may comprise at least about 5 wt. % of the pollutant mitigating agent. In another refinement, the coating composition may comprise not greater than about 40 wt. % of the pollutant mitigating agent.

The coating composition may include components in addition to the resin, the pollutant mitigating agent and the liquid vehicle. In one characterization, the coating composition comprises a magnesium compound selected from the group consisting of magnesium hydroxide, magnesium oxide, and combinations thereof. In one refinement, the magnesium compound comprises magnesium hydroxide. In another refinement, the magnesium compound comprises magnesium oxide. The coating composition may comprise at least about 0.1 wt. % of the magnesium compound, and may comprise not greater than about 5 wt. % of the magnesium compound.

In another characterization, the coating composition comprises an alginate. In one refinement, the alginate is selected from the group consisting of potassium alginate, sodium alginate, calcium alginate and combinations thereof. The coating composition may comprise at least about 0.2 wt. % of the alginate, and may comprise not greater than about 10 wt. % of the alginate.

In another characterization, coating composition comprises a pigment. The pigment may be selected from the group consisting of titanium dioxide and a mica. The coating composition may comprise at least about 5 wt. % of the pigment, and may comprise not greater than about 20 wt. % of the pigment. The coating composition may also be characterized as having a stoichiometric ratio of pollutant mitigating agent to pigment of at least about 2:1, and may also be characterized as having a stoichiometric ratio of pollutant mitigating agent to pigment of not greater than about 4:1.

Other refinements to the coating composition may include the addition of other components, such as a flow agent, a surfactant, talc, calcined clay, an emulsifier, a dispersant, a coalescing agent, a biocide and a foaming agent.

In another refinement, the liquid carrier comprises water. The coating composition may comprise at least about 40 wt. % of the liquid carrier, and may comprise not greater than about 70 wt. % of the liquid carrier.

In another refinement, the coating composition comprises not greater than about 20 g/L volatile organic compounds (VOCs). In yet another refinement, the coating composition can be used to form a Class A fire resistant coating.

In another embodiment, a method for the mitigation of pollutants is disclosed. The method includes the step of applying a coating composition to a surface, and allowing the coating composition to dry to form a pollutant mitigating coating on the surface, where the coating composition comprises a resin, a pollutant mitigating agent, and a liquid carrier.

In one refinement, the coating composition is selected from the coating compositions described above. The surface may be an interior surface. In one characterization, the surface is an interior surface of a residential building. In another characterization, the surface is an interior surface of a commercial building. In one refinement, the surface is contaminated with pollutants. For example, the surface may be contaminated with at least one pollutant that originated from tobacco smoke, marijuana smoke, methamphetamine smoke, or similar substances, as well as fumes created from the storage and/or production of these and similar substances.

The applying step may include applying the coating composition to the surface using at least one of a brush, a roller and a sprayer. In one characterization, the applying step comprises applying the coating composition to the surface using a sprayer. In one refinement, the sprayer comprises a nozzle tip having a tip diameter of at least about 0.013 inch and not greater than about 0.021 inch.

### DESCRIPTION OF THE FIGURES

FIG. 1 illustrates the concentration of re-emitted ammonia over time for a sample that is imbibed with ammonia and is treated with a coating composition according to the present disclosure.

FIG. 2 illustrates the concentration of re-emitted 2-butatone (MEK) over time for a sample that is imbibed with 2-butatone and is treated with a coating composition according to the present disclosure.

FIG. 3 illustrates the concentration of re-emitted benzene over time for a sample that is imbibed with benzene and is treated with a coating composition according to the present disclosure.

FIG. 4 illustrates the concentration of re-emitted naphthalene over time for a sample that is imbibed with naphthalene and is treated with a coating composition according to the present disclosure.

### DESCRIPTION OF THE EMBODIMENTS

Disclosed herein are coating compositions, methods for coating a surface with the coating compositions, and the coated surfaces. The coated surfaces are effective for the mitigation of surface pollutants, e.g., thirdhand smoke pollutants that are disposed on the surface, e.g., an interior wall, and present a health risk to those who are exposed to the coated surface. To form the coated surface, the coating compositions may be applied to a clean (substantially non-contaminated) surface, or may be applied to a surface that has already been contaminated with such pollutants. In the former case, the surface coating will mitigate the adverse effects of subsequent thirdhand smoke. In the latter case, the surface coating will mitigate those pollutants already contaminating the surface, as well as mitigating subsequent thirdhand smoke pollutants. In addition to mitigating pollutants from thirdhand smoke, pollutants from other activities may also be mitigated by the surface coating, such as chemical pollutants from the preparation of illegal drugs (e.g., methamphetamines).

The coating composition includes several components that synergistically mitigate surface pollutants when applied to a surface. Broadly characterized, the coating composition includes a resin, a pollutant mitigating agent, and a liquid carrier. The resin (e.g., binder) is selected for the ability to mitigate pollutants, i.e., to bind pollutants to the surface coating in a manner that the pollutants are less likely to re-enter the surrounding environment. The resin may be selected from acrylic resins, particularly acrylic resins that include a vinyl monomer. Particular examples include, but are not limited to, vinyl acetate-ethylene resin (VAE), styrene acrylic resin, and combinations of these resins. VAE is a copolymer of vinyl acetate and ethylene, and in one characterization the vinyl acetate content ranges from about 60% to about 95% of the formulation. These resins have been found to be particularly effective for the mitigation of pollutants from smoke.

In another embodiment, the resin comprises an elastomeric resin, e.g., an elastomer modified resin. Such elastomeric resins may be used as the sole resin, or as a complement to any of the resins discussed above. While not wishing to be bound by any theory, it is believed that such elastomeric resins may provide or enhance the mitigation of pollutants through an encapsulation mechanism.

The coating composition also includes a pollutant mitigating agent. Although referred to herein as a pollutant mitigating agent, it is to be understood that the combined components of the coating are effective for pollutant mitigation. That is, it is not the pollutant mitigating agent on its own that mitigates the pollutants, but it is the synergistic effect of the combined components.

The pollutant mitigation agent may comprise a phosphate compound. Examples of useful phosphate compounds include those that are commonly referred to as apatites. Apatites are calcium phosphate compounds that include relatively high concentrations of hydroxide ion (OH⁻), fluorine ion (F⁻) and/or chlorine ion (Cl⁻). The base calcium phosphate is typically in the form of Ca₁₀(PO₄)₆ with the end member being (OH,F,Cl)₂. Among these compounds, the pollutant mitigating agent may particularly be selected from calcium phosphates such as monocalcium phosphate Ca(H₂PO₄)₂ (sometimes referred to as calcium biphosphate), tricalcium phosphate Ca₃(PO₄)₂, and combinations thereof. Monocalcium phosphate may also be used in its hydrated form, e.g., Ca(H₂PO₄)₂.H₂O.

The liquid carrier may comprise water. The use of water as the liquid carrier advantageously reduces the VOCs of the composition, e.g., as compared to liquid carriers that comprise appreciable amounts of organic compound.

Thus, the coating composition comprises at least a resin, a pollutant mitigating agent and a liquid vehicle. To provide a coating with a high degree of efficacy for the mitigation of pollutants, the coating composition may include at least about 2 wt. % of the a pollutant mitigating agent, such as at least about 5 wt. % of the pollutant mitigating agent, or even at least about 7.5 wt. % of the a pollutant mitigating agent. However, the inclusion of too high of a concentration of a pollutant mitigating agent may have adverse effects on the viscosity of the coating composition. The coating composition may comprise not greater than about 40 wt. % of the pollutant mitigating agent, such as not greater than about 30 wt. % of the pollutant mitigating agent, such as not greater than about 25 wt. % of the a pollutant mitigating agent, such as not greater than about 20 wt. % of the a pollutant mitigating agent, or even not greater than about 15 wt. % of the a pollutant mitigating agent. In one very particular embodiment, the coating composition comprises about 10 wt. % of a pollutant mitigating agent.

In addition to functioning as a binder for the coating, the selected resin works in combination with the pollutant mitigating agent to bind pollutants in the coating. To provide the coating with a high degree of efficacy for the mitigation of pollutants, the coating composition may comprise at least about 10 wt. % of the resin, such as at least about 15 wt. % of the resin, or even at least about 20 wt. % of the resin. Too high a concentration of the resin may result in a viscosity that is too high for ease of application of the coating composition to a surface. The coating composition may comprise not greater than about 40 wt. % of the resin, such as not greater than about 30 wt. % of the resin, or even not greater than about 25 wt. % of the resin. In one very particular embodiment, the coating composition includes about 22 wt. % of the resin. When referring to the concentration of the resin herein, the weight percentages refer to the mass of the copolymer emulsion. The emulsion may advantageously include water as a carrier for the emulsion.

The concentration of the liquid carrier is typically selected to adjust the viscosity of the coating composition, and the liquid carrier concentration may be influenced by the concentration of the binders in the composition, e.g., including the resin discussed above, and may be influenced by upon the intended method for application of the coating composition onto the surface, as is discussed below. To provide a coating composition having a sufficiently low viscosity (e.g., sufficient flowability) for most application methods, the coating composition will typically include at least about 40 wt. % of the liquid carrier, such as at least about 45 wt. % of the liquid carrier. To ensure that the coating compositions do not have too low of a viscosity (e.g., too thin to be applied and form a thick coating), the coating composition will typically include not greater than about 70 wt. % of the liquid carrier, such as not greater than about 60 wt. % of the liquid carrier. In one particular embodiment, the coating composition includes about 49 wt. % of the liquid carrier.

The coating composition may include other components, e.g., other compounds, to assist in the mitigation of pollutants and/or the other desirable properties of the coating composition or the desirable properties of the coating. In one embodiment, the coating composition also comprises a magnesium compound, such as a magnesium compound selected from the group consisting of magnesium hydroxide, magnesium oxide, and combinations thereof. It is believed that the inclusion of such a magnesium compound further enhances the ability of the coating to mitigate pollutants. The coating composition may include at least about 0.05 wt. % of a magnesium compound, such as at least about 0.1 wt. % of a magnesium compound, or even at least about 0.15 wt. % of a magnesium compound. Typically, the coating composition will include not greater than about 5 wt. % of the magnesium compound, such as not greater than about 2 wt. % of the magnesium compound, such as not greater than about 1 wt. % of a magnesium compound, or even not greater than about 0.5 wt. % of a magnesium compound. In one particular embodiment, the coating composition includes about 0.2 wt. % of a magnesium compound.

In one embodiment, the coating composition also comprises an alginate (e.g., alginic acid or alginate salt). For example, the alginate may be selected from the group consisting of potassium alginate, sodium alginate, calcium alginate and combinations thereof. The inclusion of an alginate may further enhance the mitigation of pollutants by the coating. The coating composition may comprises at least about 0.2 wt. % of an alginate, such as at least about 0.5 wt. % of an alginate. Further, the coating composition may comprise not greater than about 5 wt. % of an alginate, such as not greater than about 2 wt. % of an alginate. In one particular embodiment, the coating composition comprises about 0.8 wt. % of an alginate.

The coating compositions disclosed herein may include components that influence the opacity and/or color of the coating. For example, the coating composition may comprise an effective amount of a pigment. Examples of useful pigments include, but are not limited to, metal oxides such as titanium dioxide (TiO₂) and mica. Other non-limiting examples of useful pigments include those that impart an aesthetically pleasing color to the coating. It will be appreciated that various combinations of pigments may be used to achieve a desired appearance. The coating composition may include at least about 5 wt. % of a pigment to impart sufficient opacity to the coating. Typically, the coating composition will include not greater than about 20 wt. % of a pigment. In one particular embodiment, the coating composition includes about 9.6 wt. % of a pigment.

While the individual concentrations of the resin and the pigment may lie within the foregoing parameters, the coating composition may also be characterized by the relative concentrations of these two components. Thus, in one characterization the stoichiometric ratio of pollutant mitigating agent to the pigment is at least about 2:1, such as at least about 5:2. In another characterization, the stoichiometric ratio of pollutant mitigating agent to the pigment is not greater than about 4:1, such as not greater than about 3:1.

The coating composition may include other additives for the modification or enhancement of one or more properties of the coating composition and/or the surface coating. Such additives may include, but are not limited to, flow agents, surfactants, talc, calcined clays, emulsifiers, dispersants, coalescing agents, biocides and foaming agents. Typically, the coating composition will comprise not greater than about 10 wt. % of the other additives, such as not greater than about 7.5 wt. % of the other additives.

The coating composition disclosed herein may advantageously have a relatively low concentration of volatile organic compounds (VOCs). VOCs are undesirable from an environmental and worker safety standpoint. In one embodiment, the coating composition comprises not greater than about 30 grams per liter (g/L) VOCs, such as not greater than about 20 g/L VOCs, and even not greater than about 18 g/L VOCs.

The coating composition disclosed herein may also be capable of forming a highly fire resistant coating. In one embodiment, the coating composition is capable of forming a coating that is Class A fire resistant, e.g., having a flame spread rating of not greater than 25 utilizing the ASTM E84 Standard Test Method for Surface Burning Characteristics of Building Materials. In one characterization, the coating formed by the coating composition may have a flame spread rating of not greater than 20, such as not greater than 15, such as not greater than 10, or even not greater than 5.

The present disclosure is also directed to methods for the mitigation of pollutants. The method includes applying a coating composition to a surface and allowing the coating composition to dry to form a pollutant mitigating surface coating, wherein the coating composition comprises a resin, a pollutant mitigating agent, and a liquid carrier. The coating composition may be a coating composition that is described in detail above.

The method is particularly useful in environments that have been, or may be, subjected to concentrations of secondhand smoke, such as from tobacco and/or marijuana use. For example, the coating composition may be applied to an interior surface, such as to an interior surface of a residential building, or to an interior surface of a commercial building (e.g., a “cigar bar”) where a building owner may wish to reduce liability for the effects of thirdhand smoke. For example, the coating composition may be applied to a surface that is substantially clean (e.g., including substantially no pollutants), or may be applied to a surface that was previously contaminated with pollutants. In the latter case, the surface onto which the coating composition is applied may comprise at least one pollutant that originated from tobacco smoke or cannabis smoke (e.g., may comprise thirdhand smoke).

The coating composition may be applied to the surface using at least one of a brush, a roller and a sprayer. For rapid surface coverage, the coating composition may be applied using a sprayer. In one characterization, the sprayer includes a nozzle tip having a tip diameter of at least about 0.013 inch and not greater than about 0.021 inch.

The present invention is also directed to a surface having a surface coating, i.e., to a coated surface. As is noted above, the surface may be an interior surface where appreciable concentrations of thirdhand smoke may form. The surface coating includes a resin and a pollutant mitigating agent. Advantageously, the surface coating may have a relatively high solids content. In one embodiment, the surface coating has a solids content of at least about 30 wt. %, such as at least about 35 wt. %, such as at least about 40 wt. % or even at least about 45 wt. %. As is noted above, the surface coating may also have a high degree of fire resistance.

### EXAMPLES

A pollutant mitigating surface coating is formed from a coating composition as described herein. The coating composition includes the following components.

TABLE I

| Component | Concentration (wt. %) |
|---|---|
| Water | 40-70 |
| Pigment | 5-20 |
| Magnesium oxides | 0.1-5 |
| Styrene acrylic emulsion | 10-40 |
| Insoluble Phosphate Salts | 5-40 |
| Mica | >1 |
| Alginate salt | 0.2-10 |
| Other Additives | 4-6 |

After application of the coating composition and drying to form a coated surface, coated surface is subjected to a blind smell test comparing it to other commercial odor mitigating products. To conduct the odor test, 6″×6″ sections of drywall are subjected to a large amount of concentrated tobacco or marijuana smoke. The two sets of drywall sections are then cut into 1″×6″ samples and each sample is coated with odor control products and allowed to cure for 7 days. Each coating composition is used to coat one sample of tobacco contaminated drywall and one sample of marijuana contaminated drywall.

The samples are then randomized, arbitrarily labeled, and subjected to a blind smell test by 12 study participants. The participants are instructed to smell each piece of drywall and to report if they could detect any smoke odors. After the test is completed, each sample is coated with a second coat of respective product and allowed to cure for another seven days. The samples are then re-randomized, arbitrarily labeled, and subjected to another blind smell test. The coating composition disclosed herein is able to block/reduce the odor from both tobacco and marijuana to amounts undetectable by any of the participants in the blind study with a single coat.

In another example, a solution of 38.5% ammonium hydroxide is placed into five glass canning jars. Whatman Grade 1 paper filters with different coatings were sealed onto the jars. The coatings included 4 different prior art odor absorbing products, and one coating composition according to the present disclosure. The samples are then randomized, arbitrarily labeled, and subjected to a blind smell test by 12 study participants. The coating composition disclosed herein is able to completely block the odor from the ammonia.

In another example, a coating composition according to the present disclosure is used to coat a surface that has been exposed to pollutants, and that will reemit volatile organic compounds (VOCs) and ammonia (NH₃). A 10″×10″ sample of drywall and a glass canning jar that has not been exposed to substantial levels of pollutant that reemits VOCs or ammonia is placed in an air chamber and sampled, specifically sampled via a Summa canister in order to measure the VOCs emitted from the polluted sample. Ammonia is sampled using a sorbent tube. This is done to establish a baseline (“Day-1”) pollutant level for the samples.

Thereafter, the drywall sample is exposed to a concentrated amount of marijuana smoke. The canning jar is filled with an ammonium hydroxide solution that will emit ammonia gas. After exposure (“Day 0”), the VOC levels and ammonia levels of the samples are measured. The drywall sample is then coated with a composition according to the present disclosure, specifically the composition listed in Table I above. A Whatman Grade 1 paper filter is also coated with the composition and is sealed over the canning jar.

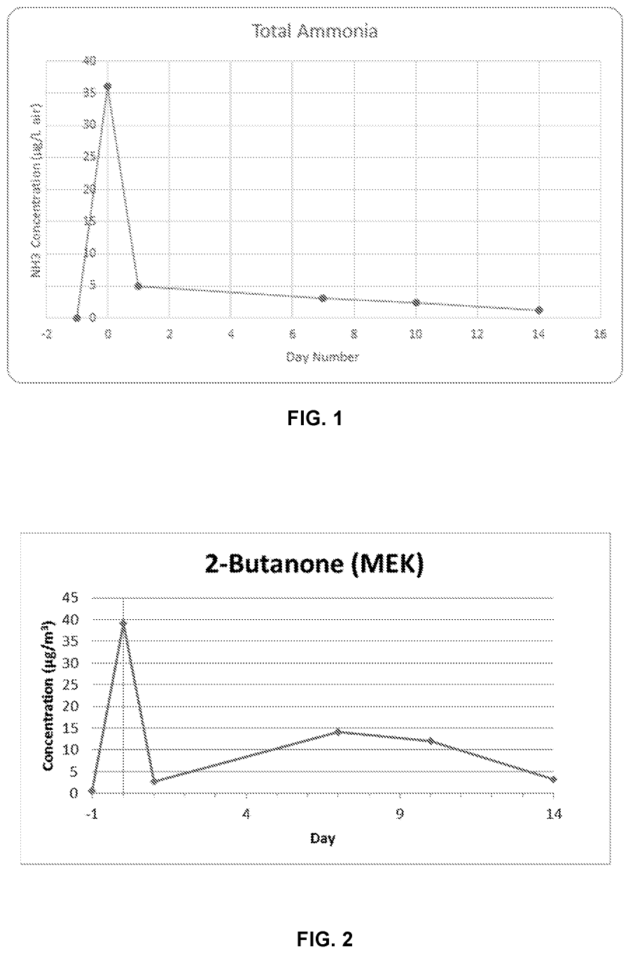

After coating, the VOC levels and ammonia levels are measured at various intervals over a 14 day period. The ammonia measurement is taken on 4 times over a 14-day period. All measurements occurred over an 8 hour period to determine a time weighted average (TWA). The results for ammonia are illustrated in FIG. 1. As illustrated in FIG. 1, the baseline concentration for ammonia (Day −1) is about 0.083 μg/L. After exposure, the Day 0 concentration of ammonia increases significantly to about 35 μg/L, which is considered a hazardous level under the current OSHA PEL (permissible exposure limit).

After application of the coating composition (Day 1), the ammonia concentration drops to about 5 μg/L. Further measurements are taken on Days 7, 10 and 14, and show a further reduction in ammonia concentration over the period with a Day 14 concentration of about 1.3 μg/L. This concentration is below the detectable limit of ammonia via the human nose of 5 μg/L.

VOCs are measured using a Summa canister, also over a 14 day period. Known VOCs found in marijuana smoke include 2-Butanone (MEK), acetone, methylbenzene (toluene), naphthalene and styrene. These VOCs are measured, along with trichloroethylene, tetrachloroethylene, ETBE, bromomethane and 1,2-dichloropropane.

After exposure to the marijuana smoke, the concentration of total VOCs is about 176 μg/m³. Immediately after application of the coating composition, the total VOCs are reduced to about 2.5 μg/m³. The concentration of VOCs increases slightly through Day 10 due to the curing of the coating composition. By Day 14, the coating has substantially cured and the VOC concentration is reduced to about 3.2 μg/m³.

Certain components of the VOCs are measured separately. FIG. 2 illustrates the results for 2-butatone. As can be seen in FIG. 2, the initial (Day 0) concentration of 2-butatone is about 40 μg/m³. The concentration reduces to about 2.5 μg/m³ on Day 1. At days 7 and 10, the concentration increases slightly, likely due to curing of the coating. By day 14, the concentration is back down to about 4 μg/m³.

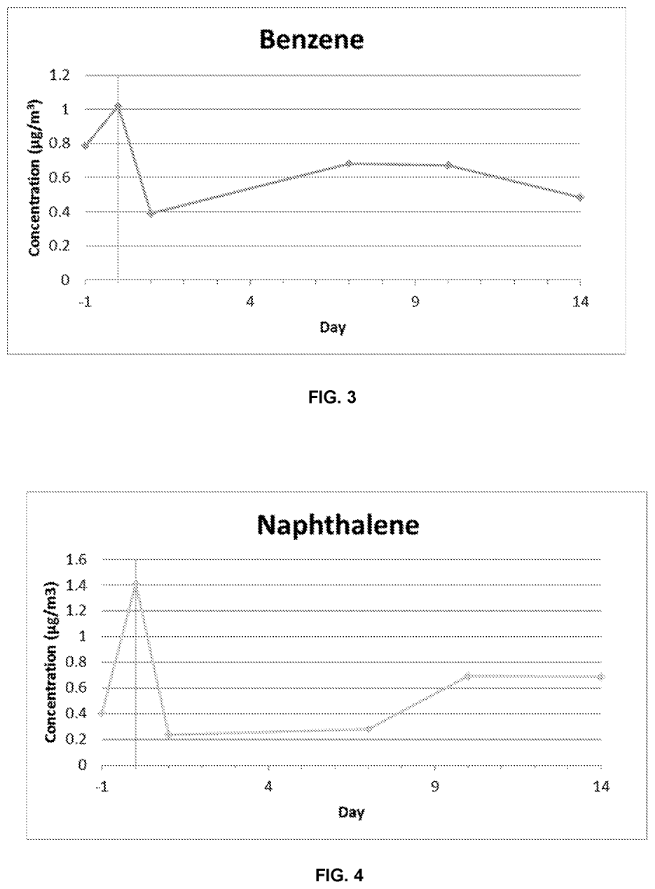

FIG. 3 illustrates the results for benzene. As can be seen in FIG. 3, the initial (Day 0) concentration of benzene is about 1.0 μg/m³. The concentration reduces to about 0.4 μg/m³ on Day 1. At days 7 and 10, the concentration again increases slightly, likely due to curing of the coating. By day 14, the concentration is back down to about 0.5 μg/m³.

FIG. 4 illustrates the results for benzene. As can be seen in FIG. 4, the initial (Day 0) concentration of benzene is about 1.4 μg/m³. The concentration reduces to about 0.2 μg/m³ on Day 1. At days 7 and 10, the concentration again increases slightly, and by day 14, the concentration is about 0.7 μg/m³, half of the initial concentration.

The coating composition disclosed herein is found to most effectively mitigate pollutants with a combination of a calcium phosphate compound and a specific resin. Pure acrylic resin with no calcium phosphate compound has very little reduction in odor. The participants in the blind study all report very strong smells. Addition of a calcium phosphate compound, such as monocalcium phosphate and tricalcium phosphate, reduces both tobacco and marijuana odors in the blind study. The addition of alginate further increases odor reduction. When a pure acrylic resin is substituted for vinyl acetate ethylene resin, the combination of a pure acrylic resin, calcium phosphate and alginate performs extremely well in the blind odor blocking study. Small additions of magnesium oxides provide additional odor blocking capabilities, and lend to a more fire resistant product as an additional benefit.

While various embodiments of coating composition, method for coating and a coated surface have been described in detail, it is apparent that modifications and adaptations of those embodiments will occur to those skilled in the art. However, it is to be expressly understood that such modifications and adaptations are within the spirit and scope of the present disclosure.

What is claimed is:

1. A coating composition formulated for the mitigation of pollutants, comprising:
a resin;
a pollutant mitigating agent; and
a liquid carrier.

2. The coating composition recited in claim 1, wherein the resin is selected from the group consisting of vinyl acetate-ethylene resin, styrene acrylic resin, elastomeric resins and combinations thereof.

3. The coating composition recited in claim 2, wherein the resin comprises vinyl acetate-ethylene resin.

4. The coating composition recited in claim 2, wherein the resin comprises styrene acrylic resin.

5. The coating composition recited in any one of claims 1 to 4, wherein the coating composition comprises at least about 10 wt. % of the resin.

6. The coating composition recited in any one of claims 1 to 4, wherein the coating composition comprises not greater than about 40 wt. % of the resin.

7. The coating composition recited in any one of claims 1 to 6, wherein the pollutant mitigating agent comprises a phosphate compound.

8. The coating composition recited in claim 7, wherein the pollutant mitigating agent is selected from the group consisting of monocalcium phosphate, tricalcium phosphate, and combinations thereof.

9. The coating composition recited in claim 8, wherein the pollutant mitigating agent comprises monocalcium phosphate.

10. The coating composition recited in claim 8, wherein the pollutant mitigating agent comprises tricalcium phosphate.

11. The coating composition recited in any one of claims 1 to 10, wherein the coating composition comprises at least about 5 wt. % of the pollutant mitigating agent.

12. The coating composition recited in any one of claims 1 to 11, wherein the coating composition comprises not greater than about 40 wt. % of the pollutant mitigating agent.

13. The coating composition recited in any one of claims 1 to 12, further comprising a magnesium compound selected from the group consisting of magnesium hydroxide, magnesium oxide, and combinations thereof.

14. The coating composition recited in claim 13, wherein the magnesium compound comprises magnesium hydroxide.

15. The coating composition recited in claim 13, wherein the magnesium compound comprises magnesium oxide.

16. The coating composition recited in any one of claims 13 to 15, wherein the coating composition comprises at least about 0.1 wt. % of the magnesium compound.

17. The coating composition recited in any one of claims 13 to 16, wherein the coating composition comprises not greater than about 5 wt. % of the magnesium compound.

18. The coating composition recited in any one of claims 1 to 17, further comprising an alginate.

19. The coating composition recited in claim 18, wherein the alginate is selected from the group consisting of potassium alginate, sodium alginate, calcium alginate and combinations thereof.

20. The coating composition recited in any one of claims 18 to 19, wherein the coating composition comprises at least about 0.2 wt. % of the alginate.

21. The coating composition recited in any one of claims 18 to 20, wherein the coating composition comprises not greater than about 10 wt. % of the alginate.

22. The coating composition recited in any one of claims 1 to 21, further comprising a pigment.

23. The coating composition recited in claim 22, wherein the pigment is selected from the group consisting of titanium dioxide and a mica.

24. The coating composition recited in any one of claims 22 to 23, wherein the coating composition comprises at least about 5 wt. % of the pigment.

25. The coating composition recited in any one of claims 22 to 24, wherein the coating composition comprises not greater than about 20 wt. % of the pigment.

26. The coating composition recited in any one of claims 22 to 25, wherein the stoichiometric ratio of pollutant mitigating agent to pigment is at least about 2:1.

27. The coating composition recited in any one of claims 22 to 26, wherein the stoichiometric ratio of pollutant mitigating agent to pigment is not greater than about 4:1.

28. The coating composition recited in any one of claims 1 to 27, wherein the coating composition comprises at least one of a flow agent, a surfactant, talc, calcined clay, an emulsifier, a dispersant, a coalescing agent, a biocide and a foaming agent.

29. The coating composition recited in any one of claims 1 to 28, wherein the liquid carrier comprises water.

30. The coating composition recited in any one of claims 1 to 29, wherein the coating composition comprises at least about 40 wt. % of the liquid carrier.

31. The coating composition recited in any one of claims 1 to 30, wherein the coating composition comprises not greater than about 70 wt. % of the liquid carrier.

32. The coating composition recited in any one of claims 1 to 31, wherein the coating composition comprises not greater than about 20 g/L volatile organic compounds (VOCs).

33. The coating composition recited in any one of claims 1 to 32, wherein the coating is a Class A fire resistant coating.

34. A method for the mitigation of pollutants, comprising the step of:
applying a coating composition to a surface; and
allowing the coating composition to dry to form an pollutant mitigating surface coating,
wherein the coating composition comprises a resin, a pollutant mitigating agent, and a liquid carrier.

35. The method recited in claim 34, wherein the coating composition comprises a coating composition as recited in any of claims 2 to 33.

36. The method recited in any one of claims 34 to 35, wherein the surface is an interior surface.

37. The method recited in claim 36, wherein the surface is an interior surface of a residential building.

38. The method recited in claim 36, wherein the surface is an interior surface of a commercial building.

39. The method recited in any one of claims 34 to 38, wherein the surface is contaminated with pollutants.

40. The method recited in claim 39, wherein the surface is contaminated with at least one pollutant that originated from tobacco smoke, cannabis smoke or methamphetamine smoke.

41. The method recited in claim 40, wherein the surface is contaminated with at least one pollutant that originated from the production or storage of tobacco, marijuana, methamphetamines, or similar substances.

42. The method recited in any one of claims 34 to 41, wherein the applying step comprises applying the coating composition to the surface using at least one of a brush, a roller and a sprayer.

43. The method recited in claim 42, wherein the applying step comprises applying the coating composition to the surface using a sprayer.

44. The method recited in claim 43, wherein sprayer comprises a nozzle tip having a tip diameter of at least about 0.013 inch and not greater than about 0.021 inch.
